(19) United States
(12) Patent Application Publication
(10) Pub. No.: US 2026/0312662 A1
(43) Pub. Date: Oct. 8, 2026

(54) BEAM TRAINING FOR WIRELESS DEVICES INCLUDING MECHANICALLY DISPLACEABLE ANTENNA PANELS

(71) Applicant: QUALCOMM Incorporated, San Diego, CA (US)

(72) Inventors: Vasanthan RAGHAVAN, West Windsor Township, NJ (US); Tao LUO, San Diego, CA (US)

(21) Appl. No.: 19/423,104

(22) Filed: Dec. 17, 2025

Related U.S. Application Data
(60) Provisional application No. 63/782,725, filed on Apr. 3, 2025.

(51) Int. Cl. H04B 7/06; H01Q 1/24; H01Q 21/29

(52) U.S. Cl. CPC H04B 7/06952; H01Q 1/246; H01Q 21/29

(57) ABSTRACT

Various aspects of the present disclosure generally relate to wireless communication. In some aspects, a user equipment (UE) may transmit, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The UE may perform the beam training procedure in accordance with the one or more parameters. Numerous other aspects are described.

### CROSS-REFERENCE TO RELATED APPLICATION

This Patent Application claims priority to U.S. Provisional Patent Application No. 63/782,725, filed on Apr. 3, 2025, entitled “BEAM TRAINING FOR WIRELESS DEVICES INCLUDING MECHANICALLY DISPLACEABLE ANTENNA PANELS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with beam training for wireless devices including mechanically displaceable antenna panels.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE) for wireless communication. The UE may include one or more memories and one or more processors coupled to the one or more memories. The one or more processors may be configured to transmit, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The one or more processors may be configured to perform the beam training procedure in accordance with the one or more parameters.

Some aspects described herein relate to a network node for wireless communication. The network node may include one or more memories and one or more processors coupled to the one or more memories. The one or more processors may be configured to receive, from a UE, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The one or more processors may be configured to perform the beam training procedure in accordance with the one or more parameters.

Some aspects described herein relate to a method of wireless communication performed by a UE. The method may include transmitting, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The method may include performing the beam training procedure in accordance with the one or more parameters.

Some aspects described herein relate to a method of wireless communication performed by a network node. The method may include receiving, from a UE, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The method may include performing the beam training procedure in accordance with the one or more parameters.

Some aspects described herein relate to a non-transitory computer-readable medium that stores a set of instructions for wireless communication by an UE. The set of instructions, when executed by one or more processors of the UE, may cause the UE to transmit, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The set of instructions, when executed by one or more processors of the UE, may cause the UE to perform the beam training procedure in accordance with the one or more parameters.

Some aspects described herein relate to a non-transitory computer-readable medium that stores a set of instructions for wireless communication by a network node. The set of instructions, when executed by one or more processors of the network node, may cause the network node to receive, from a UE, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The set of instructions, when executed by one or more processors of the network node, may cause the network node to perform the beam training procedure in accordance with the one or more parameters.

Some aspects described herein relate to an apparatus for wireless communication. The apparatus may include means for transmitting, to a network node, control information that indicates one or more parameters associated with a beam training procedure for multiple antenna panels of the apparatus that are mechanically displaceable relative to each other, wherein the one or more parameters are based at least in part on relative mechanical displacements between the multiple antenna panels during the beam training procedure. The apparatus may include means for performing the beam training procedure in accordance with the one or more parameters.

Some aspects described herein relate to an apparatus for wireless communication. The apparatus may include means for receiving, from a UE, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The apparatus may include means for performing the beam training procedure in accordance with the one or more parameters.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a device.

FIG. 3 is a diagram illustrating an example of a device including a mechanically displaceable antenna panel.

FIG. 4 is a diagram illustrating an example of joint beam training for coordinated communications.

FIG. 5 is a diagram illustrating an example associated with a rate control process configuration for performing joint beam training.

FIG. 6 is a diagram illustrating an example associated with signaling that enables beam training for wireless devices including mechanically displaceable antenna panels.

FIG. 7 is a diagram illustrating an example process performed, for example, at a user equipment (UE) or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

Lower complexity devices, such as a customer premises equipment (CPE), a machine-type communication (MTC) user equipment (UE), a reduced capability (RedCap) UE, or an Internet of Things (IoT) UE, among other examples, may be utilized in wireless communication systems to support cost-sensitive deployments, enhance energy efficiency, or reduce power consumption, among other examples. These devices may be used to support widespread IoT applications and scenarios associated with large-scale, low-cost, and low-power device connectivity, such as industrial automation, smart cities, or home automation systems, among other examples. In some examples, such devices may use large antenna arrays (e.g., 8×8 arrays, 16×8 arrays, or 16×16 arrays) to ensure wide coverage and high quality of signal reception and transmission. However, the large antenna panels (also referred to as antenna arrays) can increase complexity, area, or cost of these devices. Therefore, some lower complexity devices, such as CPEs, may use smaller antenna arrays (e.g., 4×4 antenna arrays) to reduce system cost, power consumption, or associated thermal overhead, among other examples. The devices with smaller antenna arrays may use one or more mechanisms (such as Cassegrain reflectors, along with a mechanical displacement apparatus configured to displace, rotate, tilt, or otherwise move an antenna array) to maintain or enhance effective isotropic radiated power (EIRP) and array gain of signal(s) transmitted or received via the antenna array(s). For example, a UE may include multiple antenna panels that are mechanically displaceable (e.g., moveable or adjustable) relative to each other. The antenna panel(s) may be displaceable via one or more mechanical apparatuses (e.g., one or more motors or other apparatuses).

For example, two or more antenna panels of a UE (e.g., a CPE or another type of UE) may be mechanically displaced relative to each other in order to enable coherent communication, via the two or more antenna panels, with a single device (e.g., a single network node or another UE). For example, the two or more antenna panels of a UE may be mechanically displaced to co-locate the two or more antenna panels. In other situations, the two or more antenna panels may be mechanically displaced relative to each other to enable communication with multiple devices (e.g., multiple network nodes or UEs). For example, the two or more antenna panels may be mechanically displaced relative to each other to introduce separation (e.g., angular separation or linear separation) between the two or more antenna panels to enable the UE to communicate with a first device via a first one or more antenna panels and to communicate with a second device via a second one or more antenna panels.

In some examples, a network node communicating with a CPE may update one or more rate control loops to adapt to channel fading conditions and other variables by relying on feedback from the CPE. This feedback-driven adaptative process can introduce substantial network overhead, as continuous control loop adaptations may necessitate constant overhead signaling between the CPE and the network node. For example, during joint beam training, the network node may indicate for the CPE to transition from a higher rank spatial stream configuration to a lower rank spatial stream configuration while the CPE mechanically repositions an antenna panel. Even though antenna panel repositioning may include repetitive and predictable operations, such operations may still require the network node to update rate control loops, which may increase signaling overhead and reduce the utilization of network resources. Additionally, during periods in which an antenna panel is rotating, the antenna panel may not be capable of communication. For example, the CPE may inform the network node that an antenna panel that is currently being moved may be temporarily inactive to prevent the network node from attempting to communicate with the inactive antenna panel. Such communications may further increase signaling overhead and increase latency associated with performing beam training while mechanically displacing antenna panels. Furthermore, if the network node lacks information about the mechanical displacement capabilities or the adaptative communication state capabilities of the CPE, the network node may be unable to optimize communication strategies to account for the CPE capability to dynamically adapt or switch communication states of one or more antenna panels. This could result in suboptimal communication performance.

Various aspects relate generally to enhancing beam training procedures for a UE (e.g., a CPE) with mechanically displaceable antenna panels. Some aspects more specifically relate to techniques where the UE may transmit control information to a network node, indicating parameters associated with a beam training procedure for multiple antenna panels that are mechanically adjustable relative to each other. For example, the parameters may be based on the relative mechanical displacements between the multiple antenna panels during the beam training process. Accordingly, the UE may perform the beam training procedure in accordance with the specified parameters.

In some aspects, the parameters may include a minimum duration of time to switch from one beam and antenna configuration to another beam and antenna configuration as the antenna panels are displaced from one position to another. The parameters may additionally specify the number of different positions through which the antenna panels will move during the beam training procedure, or indicate pre-trained beams to be utilized by an anchor antenna panel while one or more other antenna panels are being displaced.

In some aspects, the UE may receive, from the network node, prior to commencing the beam training procedure, configurations for a rate control process tailored to the upcoming antenna panel movements. Coordinating the rate control process based on the received configurations allows the UE to effectively manage beam training state transitions and maintain a stable communication link by adapting the communication rank as the antenna panels are mechanically adjusted. After the beam training procedure, the UE may receive from the network node an indication of the preferred beam pair and mechanical displacement positions for subsequent communications. The network node may determine such preferences based on one or more observed key performance indicators (KPIs) during the beam training, which enables fine-tuning of the communication strategies for optimized performance.

Particular aspects of the subject matter described in this disclosure can be implemented to realize one or more of the following potential technical advantages. By providing the network node with control information about the mechanical displacement activities and the corresponding beam training parameters, the UE enables the network node to efficiently manage the beam alignment process, which may conserve processing resources and reduce communication latency. This proactive approach can reduce network overhead by reducing the use of reactive adjustments and feedback-based communications associated with dynamic adaptations of rate control loops. Additionally, by leveraging historical beam training results obtained when antennas were in a non-displaced state, the UE can provide predictive insights to the network node regarding the most effective antenna configurations. This data-driven approach enables optimal resource allocation and can reduce the time and energy expended during the beam training process, as well as during subsequent communications. Further, the described techniques can be used to improve communication efficiency by optimizing antenna panel alignment and enhancing network coordination for UEs with mechanically displaceable antenna panels. This approach may conserve network resources, streamline signaling procedures, and reduce the computational burden on network nodes, which may be especially beneficial in scenarios where cost-effective CPEs are employed.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

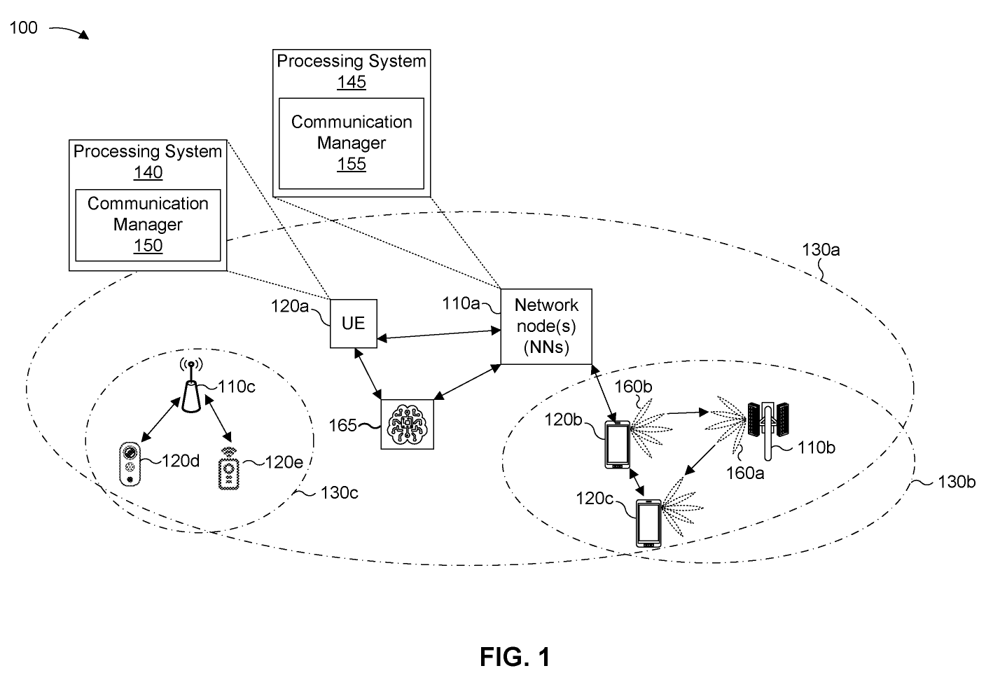

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a, a network node 110b, and a network node 110c (each of which also may be referred to herein simply as a “network node 110”). The network nodes 110 may support communications with multiple UEs 120. For example, in FIG. 1, the network nodes 110 support communication with a UE 120a, a UE 120b, a UE 120c, a UE 120d, and a UE 120e (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a, a cell 130b, and a cell 130c).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

Some UEs 120 may be considered MTC UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs.” For example, the UE 120d may be an MTC UE, or the UE 120e may be an MTC UE. An MTC UE may be, may include, or may be included in or coupled with a robot, an uncrewed aerial vehicle, a remote device, a sensor, a meter, a monitor, or a location tag. Some UEs 120 may be considered IoT devices. Some such UEs 120 may be implemented as NB-IoT (narrowband IoT) devices, such as the UE 120d or the UE 120e. An IoT or NB-IoT device may be, may include, or may be included in or coupled with an industrial machine, an appliance, a refrigerator, a doorbell camera device, a home automation device, or a light fixture, among other examples. Some UEs 120, such as the UE 120e or the UE 120e, may be considered CPEs, which may include telecommunications devices that are installed at a customer location (such as a home or office) to enable access to a service provider’s network (such as included in or in communication with the wireless communication network 100). In some examples, an MTC UE, an IoT device, or a CPE (such as the UE 120e or the UE 120e) may include one or more mechanically displaceable (e.g., moveable) antenna panels or antenna elements. As shown in FIG. 1, the UEs (e.g., the UE 120e or the UE 120e) may communicate with the network node 110c within the cell 130c. The cell 130c may provide a coverage area for an area in which the UE(s) are located, such as a factory, an indoor area, or a building, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC- CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110aor the UE 120a(for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110aor the UE 120a(for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may transmit, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; and perform the beam training procedure in accordance with the one or more parameters. Additionally, or alternatively, the communication manager 150 may perform one or more other operations described herein.

In some aspects, the network node 110 may include a communication manager 155. As described in more detail elsewhere herein, the communication manager 155 may receive, from a UE, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; and perform the beam training procedure in accordance with the one or more parameters. Additionally, or alternatively, the communication manager 155 may perform one or more other operations described herein.

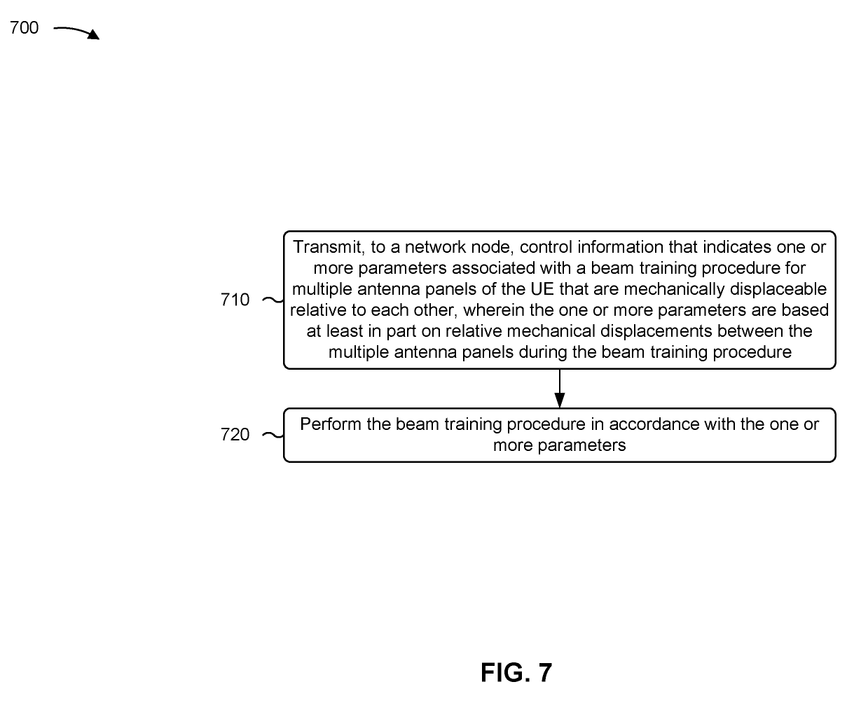

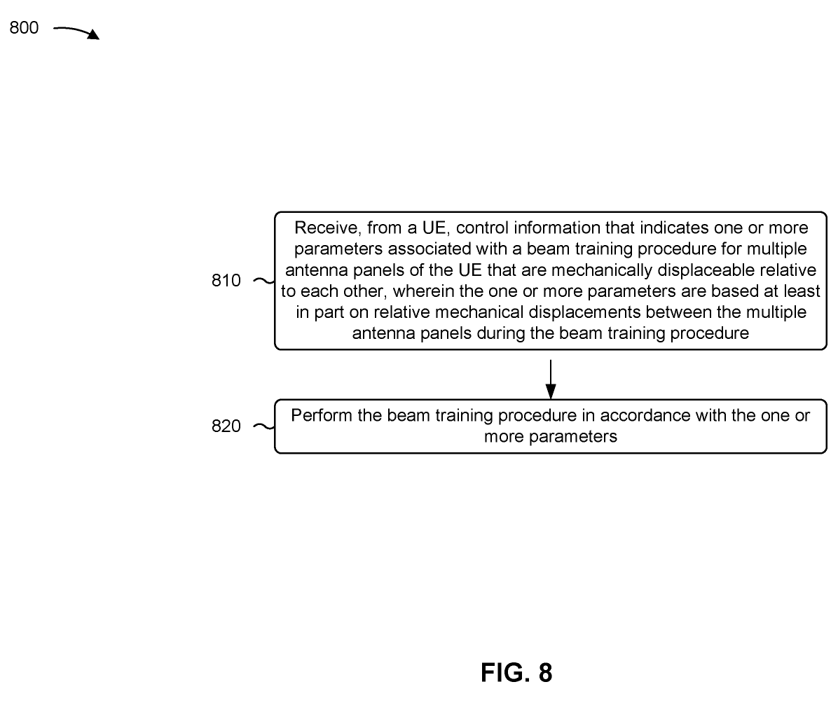

The network node 110, the processing system 145 of the network node 110, the UE 120, the processing system 140 of the UE 120, or any other component(s) of FIG. 1 may implement one or more techniques or perform one or more operations associated with beam training for wireless devices including mechanically displaceable antenna panels, as described in more detail elsewhere herein. For example, the processing system 145 of the network node 110, or the processing system 140 of the UE 120 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

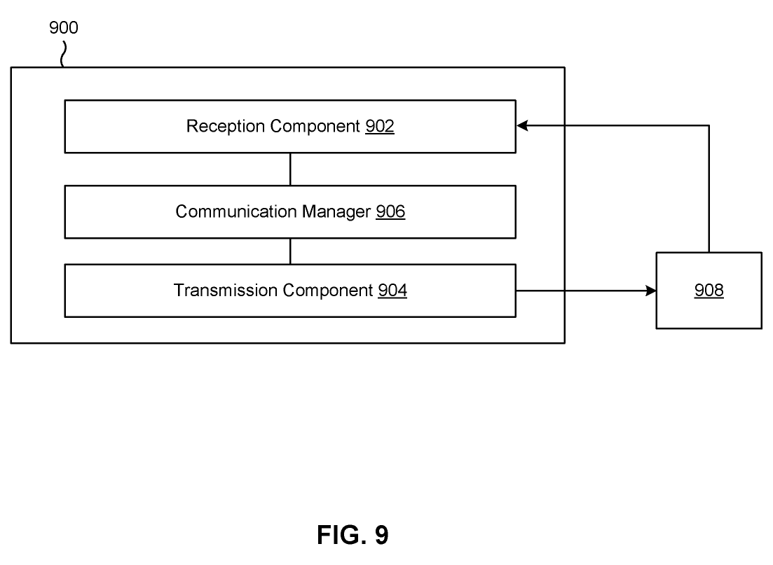

In some aspects, the UE 120 includes means for transmitting, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; or means for performing the beam training procedure in accordance with the one or more parameters. The means for the UE 120 to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

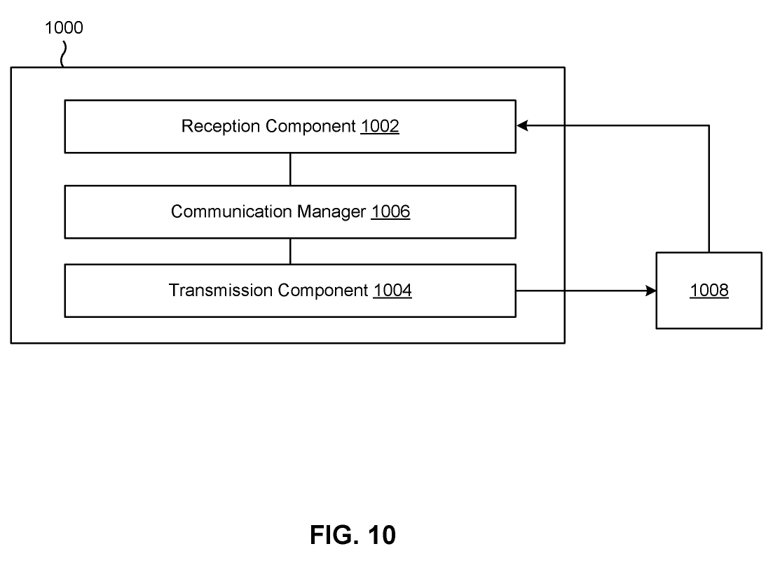

In some aspects, the network node 110 includes means for receiving, from a UE, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; or means for performing the beam training procedure in accordance with the one or more parameters. The means for the network node 110 to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

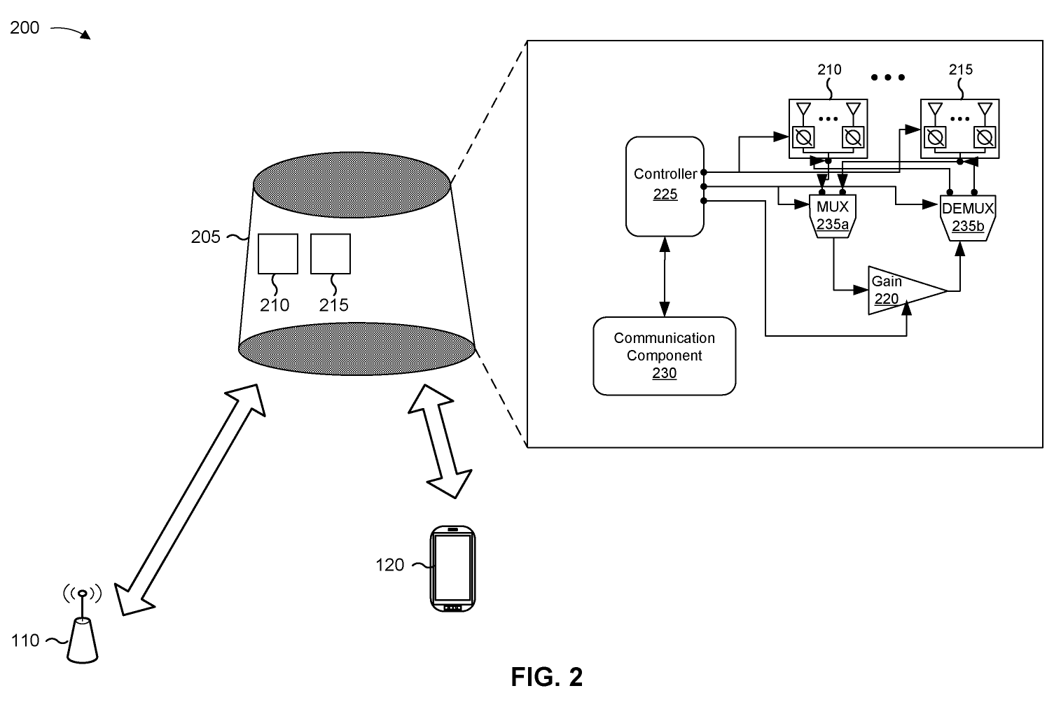

FIG. 2 is a diagram illustrating an example 200 of a device. The example 200 includes the UE 205 (e.g., that may be an example of a CPE or the UE 120e) and a network node 110 and UE 120, both connected to the UE 205 via a wireless communication link. The UE 205 may include telecommunications or information technology equipment that operates at a customer premises or physical location of a user. In some examples, the UE 205 may be configured to communicate via mmW frequency bands. The UE 205 may include a set of one or more antenna arrays or antenna panels including an antenna array. For example, the UE 205 in the example 200 include a first antenna panel 210 and a second antenna panel 215. The UE 205 may include one or more antenna panels in addition to antenna panels 210 and 215, a gain component 220, a controller 225, a communication component 230, and a multiplexer (MUX) or demultiplexer (DEMUX) (MUX/DEMUX) 235 (e.g., including a MUX 235a and a DEMUX 235b).

The antenna panels 210 or 215 may include multiple antenna elements capable of being configured for beamforming. In some examples, the first antenna panel 210 or the second antenna panel 215 may be a fixed receive antenna array capable of only receiving communications while not transmitting communications. In some examples, the first antenna panel 210 or the second antenna panel 215 may be a fixed transmit antenna array capable of only transmitting communications while not receiving communications. In some examples, the first antenna panel 210 or the second antenna panel 215 may be capable of being configured to act as a receive antenna array or a transmit antenna array, or may be configured for full duplex communications. The first antenna panel 210 or the second antenna panel 215 may be capable of communicating signals using mmW frequency bands.

The gain component 220 includes a component capable of amplifying an input signal and outputting an amplified signal. For example, the gain component 220 may include a power amplifier or a variable gain component. In some examples, the gain component 220 may have variable gain control. The gain component 220 may connect to an receive antenna array and a transmit antenna array such that a millimeter wave signal, received via the receive antenna array, can be amplified by the gain component 220 and output to the transmit antenna array for transmission. In some examples, the level of amplification of the gain component 220 may be controlled by the controller 225.

The controller 225 includes a component capable of controlling one or more other components of the UE 205. For example, the controller 225 may include a controller, a microcontroller, or a processor. The controller 225 may be an example of, or may be included in, a processing system of the UE 205, such as the processing system 140. In some examples, the controller 225 may control the gain component 220 by controlling a level of amplification or gain applied by the gain component 220 to an input signal. Additionally, or alternatively, the controller 225 may control the first antenna panel 210 or the second antenna panel 215 by configuring a beamforming configuration for the first antenna panel 210 or the second antenna panel 215 (for example, one or more phase values, one or more phase offsets, one or more power parameters, one or more beamforming parameters, a transmit beamforming configuration, or an receive beamforming configuration). Additionally, or alternative, the controller 225 may control the first antenna panel 210 or the second antenna panel 215 by configuring whether the first antenna panel 210 or the second antenna panel 215 acts as an receive antenna array or a transmit antenna array (for example, by configuring interaction or connections between the first antenna panel 210 or the second antenna panel 215 and a MUX/DEMUX 235). Additionally, or alternatively, the controller 225 may power on or power off one or more components of UE 205. In some examples, the controller 225 may control a timing of one or more of the above configurations.

The communication component 230 may include a component capable of wirelessly communicating with the network node 110 or another network node using a wireless technology other than millimeter wave (for example, via a control interface). For example, the communication component 230 may communicate with the network node 110 using a personal area network (PAN) technology (for example, Bluetooth or Bluetooth Low Energy (BLE)), a 4G or long-term evolution (LTE) radio access technology, a narrowband Internet of Things (NB-IoT) technology, a sub-6 GHz technology, or a visible light communication technology, among other examples. In some examples, the communication component 230 may use a lower frequency communication technology, and the first antenna panel 210 or the second antenna panel 215 may use a higher frequency communication technology (for example, millimeter wave). In some examples, the first antenna panel 210 or the second antenna panel 215 may be used to transfer data between the UE 205 and the network node 110, and the communication component 230 may be used to transfer control information between the UE 205 and the network node 110 (for example, a report, a configuration, or instructions to power on or power off one or more components).

The MUX/DEMUX 235 may be used to multiplex or demultiplex communications received from or transmitted to an antenna array (e.g., an antenna array of the first antenna panel 210 or an antenna array of the second antenna panel 215). For example, the MUX/DEMUX 235 may be used to switch a receive antenna array to a transmit antenna array. In some examples, one or more of the first antenna panel 210 or the second antenna panel 215, the gain component 220, the controller 225, the communication component 230, or the MUX/DEMUX 235 may perform one or more techniques associated with UE calibration of mmW devices for mechanical alignments, as described in more detail elsewhere herein.

Because millimeter wave communications have a higher frequency and shorter wavelength than other types of radio waves used for communications (for example, sub-6 GHz communications), millimeter wave communications may have shorter propagation distances and may be more easily blocked by obstructions than other types of radio waves. For example, a wireless communication that uses sub-6 GHz radio waves may be capable of penetrating a wall of a building or a structure to provide coverage to an area on an opposite side of the wall from a network node 110 that communicates using the sub-6 GHz radio waves. However, a millimeter wave may not be capable of penetrating the same wall (for example, depending on a thickness of the wall or a material from which the wall is constructed). Some techniques and apparatuses described herein use a mmW device, such as the UE 205, to increase the coverage area of a network node 110 or to extend coverage to other UEs.

The UE 205 may perform directional communication by using the antenna panels 210 or 215 and beamforming to communicate with a network node 110 via one or more beams. For example, in example 200, the UE 205 can communicate with the network node 110 via a first beam pair and can communicate with the UE 120 via a second beam pair. A beam pair may refer to a transmit (Tx) beam used by a first device for transmission and a receive (Rx) beam used by a second device for reception of information transmitted by the first device via the Tx beam.

The network node 110 may use a beam sweeping procedure to transmit communications via multiple beams over time (for example, using time division multiplexing (TDM)). The UE 205 may receive a communication via an Rx beam of the UE 205. The UE 205 may relay each received communication via multiple Tx beams of the UE 205. As used herein, relaying a communication may refer to transmitting the received communication (for example, after amplifying the received communication) without decoding the received communication or without modifying information carried in the received communication. Alternatively, relaying a received communication may refer to transmitting the received communication after decoding the received communication or modifying information carried in the received communication. In some examples, a received communication may be relayed using a different time resource, a different frequency resource, or a different spatial resource (for example, a different beam) to transmit the communication as compared to a time resource, a frequency resource, or a spatial resource in which the communication was received. The UE 120 may receive a relayed communication. In some examples, the UE 120 may generate a communication to be transmitted to the network node 110. The UE 120 may then transmit the communication to the UE 205 for relaying to the network node 110.

The first antenna panel 210 or the second antenna panel 215 may be co-located or similarly located for communications with a single network node 110. The 205 may include a mechanical displacement apparatus (for example, at least one motor) that may rotate, reflect, or displace the first antenna panel 210 or the second antenna panel 215 or any corresponding components, such as a reflector. The mechanical displacement apparatus may separate or displace the first antenna panel 210 or the second antenna panel 215. In such examples, the displacement may be linear, angular, and or rotational.

Some CPEs, such as the UE 205, may include large antenna arrays (for example, 8x8 element antenna arrays, 16x8 element antenna arrays, 16x16 element antenna arrays) which may cost more than smaller antenna arrays. As demand for lower-cost implementations of CPEs increases, CPEs may be implemented with smaller antenna arrays to reduce cost. Some CPEs, such as the UE 205, may include a reflector or a mechanical rotator corresponding to each antenna panel, such as the first antenna panel 210 or the second antenna panel 215. This may enable the UE 205 to support certain communication parameters, such as effective isotropic radiated power and array gain, without the use of large antenna arrays. Smaller antenna arrays supported by a reflector or a mechanical rotator may also support reduced power consumption, reduced thermal overhead, and reduction in overall cost of the materials to manufacture the UE 205 and area (e.g., the physical size of footprint) of the UE 205.

Other examples of the UE 205 may differ from what is described in FIG. 2. For example, the UE 205 may include additional components, fewer components, different components, or differently arranged components than those shown in FIG. 2. Furthermore, two or more components shown in FIG. 2 may be implemented within a single component, or a single component shown in FIG. 2 may be implemented as multiple components. Additionally, or alternatively, a set of components (for example, one or more components) of the UE 205 may perform one or more functions described as being performed by another set of components of UE 205.

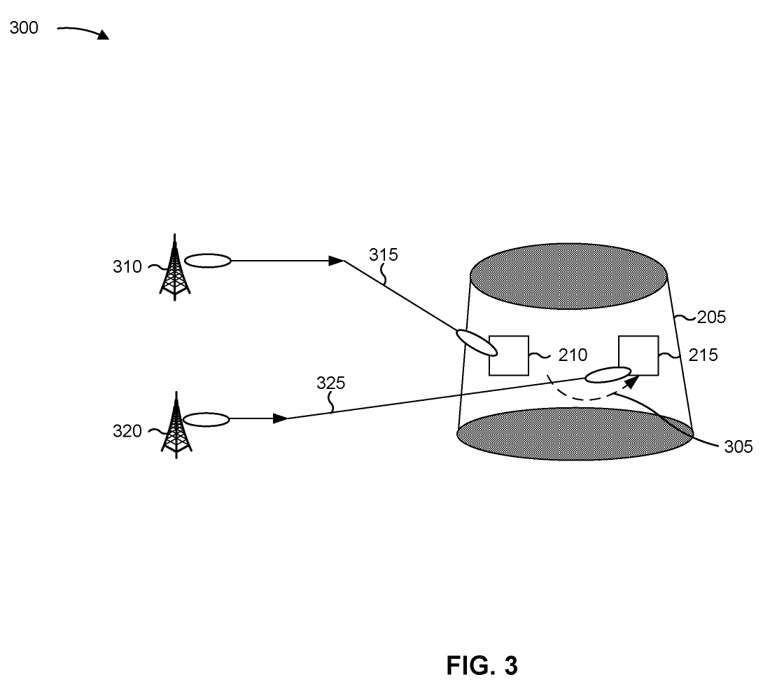

FIG. 3 is a diagram illustrating an example 300 of a device including a mechanically displaceable antenna panel. As shown in FIG. 3, the UE 205 may include the first antenna panel 210 and the second antenna panel 215. The first antenna panel 210 and the second antenna panel 215 may be mechanically displaceable (e.g., moveable or adjustable) relative to each other. For example, in accordance with being mechanically displaceable relative to each other, if the first antenna panel 210 is at fixed position in the spatial domain, then the second antenna panel 215 may move in the spatial domain from a first position that is associated with a first spatial vector that points to the fixed position to a second position that is associated with a second spatial vector that points to the fixed position. The antenna panel(s) 210 or 215 may be displaceable via one or more mechanical apparatuses (e.g., one or more motors or other apparatuses). In some examples, both the first antenna panel 210 and the second antenna panel 215 may be mechanically displaceable (e.g., a physical position or orientation of both the first antenna panel 210 and the second antenna panel 215 may be displaceable, moveable, or adjustable). In some other examples, one or more of the antenna panels (e.g., the first antenna panel 210 or the second antenna panel 215) may have a fixed position or orientation (e.g., and may not be mechanically displaceable, moveable, or adjustable).

The UE 205 may include at least one antenna panel (e.g., the first antenna panel 210 or the second antenna panel 215) for which a position or orientation is mechanically displaceable, moveable, or adjustable. Although some examples are used herein to describe or depict two antenna panels, the UE 205 may include any quantity of antenna panels (e.g., one (e.g., a single) antenna panel, three antenna panels, four antenna panels, or another quantity of antenna panels) where at least one of the antenna panel(s) is mechanically displaceable.

As shown by reference number 305, the first antenna panel 210 or the second antenna panel 215 may be mechanically displaced via one or more mechanical apparatuses (e.g., a motor). For example, the first antenna panel 210 or the second antenna panel 215 may be mechanically rotated, displaced, or otherwise moved. The displacement of the antenna panel(s) (e.g., the first antenna panel 210 or the second antenna panel 215) may be linear or angular. In some examples, such as shown in FIG. 2, the first antenna panel 210 or the second antenna panel 215 may be mechanically displaced such that the first antenna panel 210 or the second antenna panel 215 can be configured to operate as co-located panels. In such examples, the UE 205 may communicate (e.g., transmit or receive signal(s)) via both the first antenna panel 210 or the second antenna panel 215 with a single node or device (e.g., a single UE 120 or a single network node 110).

In other examples, as shown in FIG. 3, the first antenna panel 210 or the second antenna panel 215 may be mechanically displaced such that the first antenna panel 210 or the second antenna panel 215 can be configured to communicate (e.g., transmit or receive) signals associated with multiple nodes or devices. For example, as shown by reference number 305, the UE 205 may mechanically displace (e.g., rotate, move, or displace) the first antenna panel 210 or the second antenna panel 215 such that the first antenna panel 210 and the second antenna panel 215 are non-co-located. For example, the mechanical displacement may physically separate or displace the antenna panels 210 and 215 to enable the UE 205 to perform directional communications with multiple nodes or devices. For example, the mechanical displacement may cause an angular separation between the first antenna panel 210 and the second antenna panel 215. Such angular separation between the first antenna panel 210 and the second antenna panel 215 may be introduced during a mechanical alignment phase. For example, the mechanical alignment phase operation may take the UE 205 a relatively long time (for example, in the order of tens of seconds or even minutes) to complete and transition to communicating with the multiple nodes or devices. For example, the UE 205 may perform one or more mechanical displacements of the first antenna panel 210 or the second antenna panel 215 to decrease cross-talk or leakage between communications via the first antenna panel 210 and communications via the second antenna panel 215.

In some examples, the UE 205 may be enabled to perform full duplex or sub-band full duplex operations via the first antenna panel 210 and the second antenna panel 215. In such examples, the first antenna panel 210 (or, for example, a first subset of panels of the UE 205) may communicate via a first carrier frequency, a first frequency range, or a first frequency band. The second first antenna panel 210 (or, for example, a second subset of panels of the UE 205) may communicate via a second carrier frequency, a second frequency range, or a second frequency band. In such examples, the first antenna panel 210 and the second antenna panel 215 may be configured to transmit or receive signals for the same device or different devices.

As shown in FIG. 3, the UE 205 may communicate with a first device 310 (e.g., a network node 110, a UE 120, or another wireless communication device) via the first antenna panel 210. For example, the UE 205 may transmit or receive one or more signals via the first antenna panel 210 associated with a communication link 315 between the UE 205 and the first device 310. The UE 205 may communicate with a second device 320 (e.g., a network node 110, a UE 120, or another wireless communication device) via the second antenna panel 215. For example, the UE 205 may transmit or receive one or more signals via the second antenna panel 215 associated with a communication link 325 between the UE 205 and the second device 320.

The antenna panels of the UE 205 may be operating in accordance with various adaptive communication states. In some examples, both (e.g., all or multiple) antenna panels of the UE 205 may be transmitting (e.g., may be configured to transmit signals). In other examples, both (e.g., all or multiple) antenna panels of the UE 205 may be receiving (e.g., may be configured to receive signals). In other examples, the UE 205 may be operating in a full-duplex mode in which a first one or more of the antenna panels are transmitting signals at a time that at least partially overlaps with a time during which a second one or more of the antenna panels are receiving signals. In other examples, one or more of the antenna panels of the UE 205 may be inactive or powered off. In other examples, all of the antenna panels of the UE 205 may be inactive or powered off.

However, different communication states may be associated with different mechanical displacement parameters. For example, for the UE 205 to communicate with antenna panels in a given communication state, the UE 205 may mechanically displace one or more of the antenna panels. For example, if the communication state is associated with communication with a single node or device, then the UE 205 may mechanically displace one or more of the antenna panels to be co-located (e.g., to be closer together or to be oriented in similar spatial directions). In other examples, if the communication state is associated with communication with multiple nodes or devices, then the UE 205 may mechanically displace one or more of the antenna panels to be non-co-located (e.g., to be further apart or to be oriented in different spatial directions). However, a network node (or another device communicating with the UE 205) may be unaware of the communication state(s) in which the UE 205 is capable of communicating. Moreover, the network node (or other device communicating with the UE 205) may be unaware of the current mechanical positions or orientations of the antenna panels of the UE 205.

As indicated above, FIG. 3 is provided as an example. Other examples may differ from what is described with regard to FIG. 3.

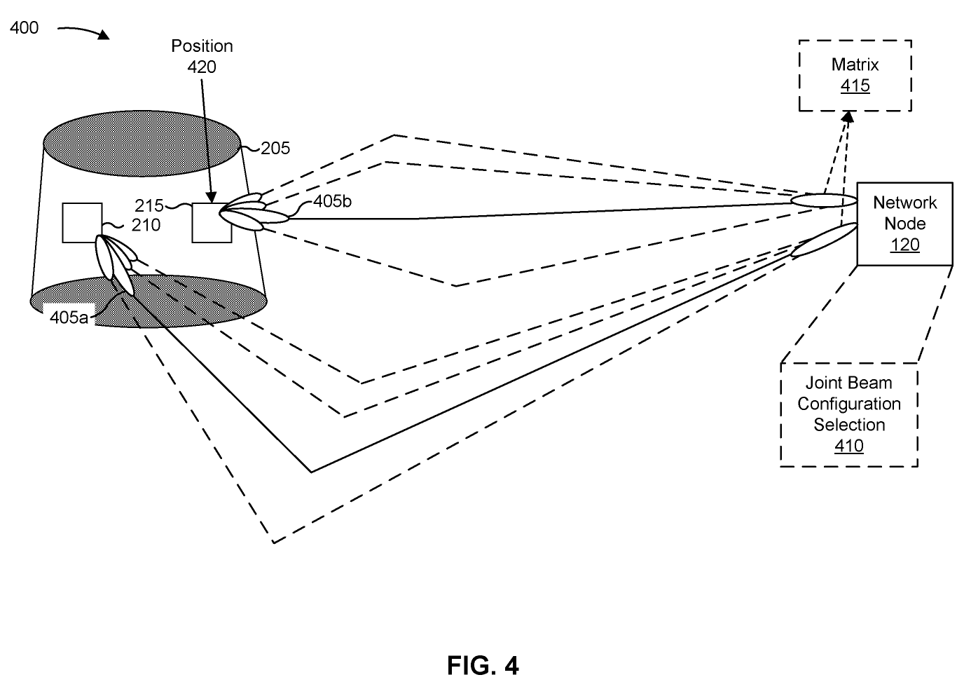

FIG. 4 is a diagram illustrating an example 400 of joint beam training for coordinated communications. In some instances, example 400 may implement or be implemented by one or more aspects of FIGS. 1-3. For instance, FIG. 4 may illustrate wireless communications between the network node 110 and the UE 205. As described elsewhere herein, the UE 205 may be an example of a CPE with mechanically displaceable antenna panels (e.g., the first antenna panel 210 and the second antenna panel 215).

In some aspects, the example 400 may describe a joint beam training procedure with panel rotation for the UE 205 (e.g., a low-cost CPE). For example, joint beam training aims to optimize the communication setup between the UE 205 and the network node 110 by considering both the beam design across the multiple antenna panels and the rotation of one antenna panel relative to another antenna panel. This dual optimization approach may increase signal quality of wireless communications performed by the UE 205 (such as in scenarios where cost constraints necessitate the use of simpler, more affordable hardware components).

In some examples, the joint beam training procedure may include the selection of beams 405 across the antenna panels of the UE 205 and the determination of the optimal position of one antenna panel relative to another antenna panel. By jointly configuring the beam selection and antenna panel positions, the UE 205 and the network node 110 may increase the efficiency and effectiveness of an established communication link. As part of the joint beam training procedure, the UE 205 may move (e.g., linearly in one or more dimensions, or rotationally) the second antenna panel 215 relative to a fixed position of the first antenna panel 210. In other words, the first antenna panel 210 may serve as an anchor antenna panel and the second antenna panel 215 may serve as a displacement antenna panel. The UE 205 may move the second antenna panel 215 to find an antenna alignment that reduces inter-panel interference, which may increase the quality of wireless communications.

To reduce inter-panel interference, the UE 205 may move the second antenna panel 215 relative to the fixed position of the first antenna panel 210. The UE 205 may move the second antenna panel 215 in one or more discrete steps. For instance, in example 400, the UE 205 may move the antenna panels from being in a co-located position to being in a non-co-located position, as described elsewhere herein.

Additionally, after moving the second antenna panel 215 relative to the first antenna panel 210, the UE 205 may train one or more beams 405 during a training period. For instance, as shown in FIG. 4, the first antenna panel 210 may be associated with a first set of beams 405 and the second antenna panel 215 may be associated with a second set of beams 405. In some examples, the first and second sets of beams 405 may cover a range of possible beam directions, enabling the network node 110 to evaluate interference levels across various combinations of beam directions. For example, the first set of beams 405 may transmit reference signals via a first frequency band (f 1) in accordance with a first channel matrix (H 1) and the second set of beams 405 may transmit reference signals via a second frequency band (f 2) in accordance with a second channel matrix (H 2). Additionally, the first antenna panel 210 and the second antenna panel 215 may be associated with any number of beams 405.

During a training period, the UE 205 may transmit reference signals (e.g., sounding reference signals (SRSs)) across the first set of beams 405 and the second set of beams 405. The UE 205 may transmit these reference signals sequentially or concurrently across the different beam directions. Accordingly, the network node 110 may receive the reference signals to evaluate the quality of each of the beams 405. For example, the network node 110 may measure various parameters associated with the received signals, such as one or more of signal strength, signal-to-noise ratio (SNR), or interference levels, among other examples. By analyzing these measurements, the network node 110 can determine which of the multiple beams 405 offers the best quality in terms of reliable and robust communication.

Accordingly, the network node 110 may use the measurements to determine which pair of beams 405 across the first set of beams 405 and the second set of beams 405 results in a lowest/low uplink interference across the various possible combinations of beam pairs. Additionally, the UE 205 and network node 110 may perform multiple training periods associated with moving the second antenna panel 215 to multiple positions relative to the fixed position of the first antenna panel 210. Therefore, based on the interference measurements obtained during the multiple training periods, the network node 110 may determine a position of the second antenna panel 215 and a corresponding beam pair at that position that results in the lowest inter-panel interference while maintaining a communication link quality that satisfies a quality threshold. For instance, in example 400, the network node 110 may determine (based on measuring reference signals for multiple positions of the second antenna panel 215) that a beam pair including a beam 405a of the first set of beams 405 and a beam 405b of the second set of beams 405 while the second antenna panel 215 is at the position 420 may result in a lowest/low inter-panel interference.

Accordingly, the network node 110 may transmit, and the UE 205 may receive, configuration information (e.g., via RRC signaling, MAC-CE signaling, or DCI signaling) that indicates for the UE 205 to place the second antenna at the position 420 and for the UE 205 to use the beam 405a for the first antenna panel 210 and to use the beam 405b for the second antenna panel 215 for one or more subsequent wireless communications with the network node 110. In some examples, the network node 110 may determine the information to include in the configuration information based on performing a joint beam configuration selection 410. Additionally, as shown in FIG. 4, the network node 110 may use a determined matrix 415 to receive wireless communications while the second antenna panel 215 is at the position 420 and the UE 205 uses the beam pair that includes the beams 405a and 405b. In some examples, the matrix 415 may be associated with multiple beam peaks or lobes.

As described herein, joint beam training with antenna panel movement for the UE 205 may involve a comprehensive optimization process that includes both beam design and antenna panel displacement. By minimizing inter-panel interference and determining the optimal rotational position of the antenna panels, the network node 110 and UE 205 may enhance wireless communication performance. Therefore, the joint beam training approach enables high-quality communication links, making it a valuable technique for cost-sensitive applications (such as a low-cost CPE).

As indicated above, FIG. 4 is provided as an example. Other examples may differ from what is described with regard to FIG. 4.

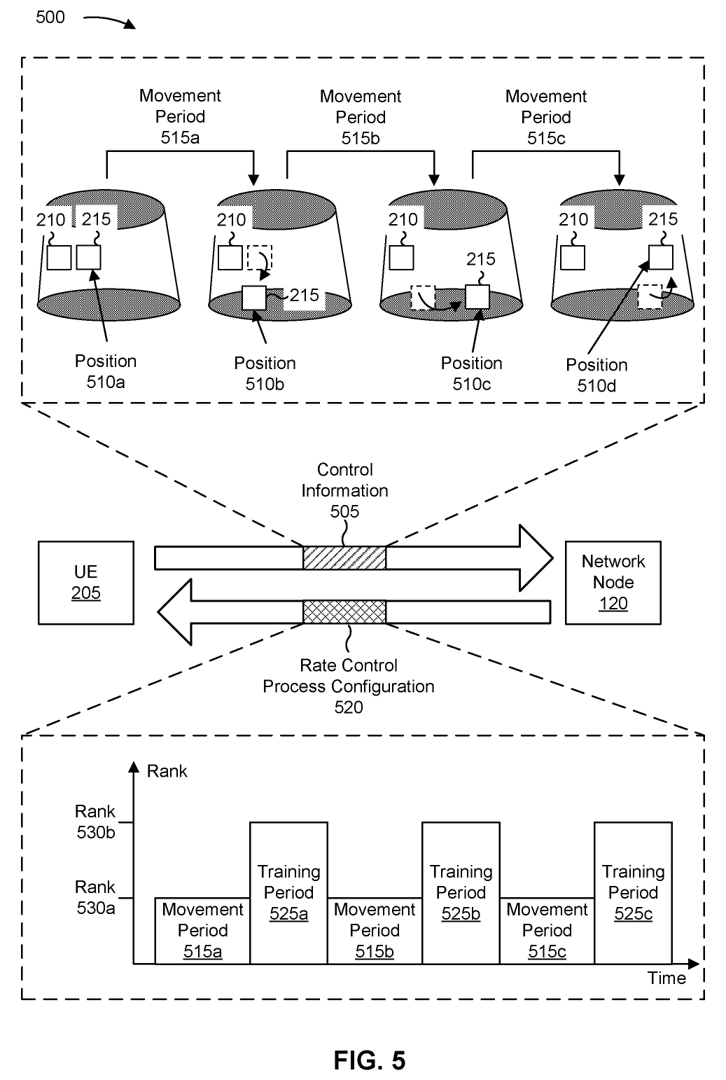

FIG. 5 is a diagram illustrating an example 500 associated with a rate control process configuration for performing joint beam training. In some instances, example 500 may implement or be implemented by one or more aspects of FIGS. 1-4. For instance, FIG. 5 may illustrate wireless communications between the network node 110 and the UE 205.

As shown in FIG. 5, the UE 205 and the network node 110 may perform a joint beam training procedure that spans one or more movement periods 515 and one or more training periods 525. For instance, the joint beam training procedure may start with a movement period 515a, where the UE 205 moves (e.g., linearly or rotationally) the second antenna panel 215 from a position 510a to a position 510b. After moving the second antenna panel 215 to the position 510b, the UE 205 may perform a first beam training during a training period 525a where the UE 205 transmits reference signals across multiple training beams of the first antenna panel 210 and the second antenna panel 215. After the training period 525a, the UE 205 moves (e.g., linearly or rotationally) the second antenna panel 215 from the position 510b to a position 510c during a movement period 515b. After moving the second antenna panel 215 to the position 510c, the UE 205 may perform a second beam training during a training period 525b. After the training period 525b, the UE 205 moves (e.g., linearly or rotationally) the second antenna panel 215 from the position 510c to a position 510d during a movement period 515c. After moving the second antenna panel 215 to the position 510c, the UE 205 may perform a third beam training during a training period 525c. In other examples, the joint beam training procedure may include any number of movement periods 515 and any number of training periods 525. Additionally, during the joint beam training procedure the first antenna panel 210 may serve as an “anchor antenna panel” that stays in a fixed position relative to the UE 205, and the second antenna panel 215 may serve as a “displacement antenna panel” that moves across the multiple positions 510 while the first antenna panel 210 stays in the fixed position.

To enable the joint training procedure, the UE 205 may transmit, and the network node 110 may receive, control information 505 (e.g., via RRC signaling, MAC-CE signaling, or UCI signaling). For example, the control information 505 may indicate one or more parameters associated with performing a joint beam training procedure.

In some examples, the control information 505 may indicate a duration of time to perform a movement period 515. In other words, the UE 205 may indicate a minimum (or permissible) amount of time for switching from a first beam pair associated with the second antenna panel 215 being at a first position 510 to switching to a second beam pair associated with the second antenna panel 215 being at a second position 510. In some examples, the duration of time to perform a movement period 515 may be associated with the UE 205 transitioning from using a first set (or group) of training beams for the second antenna panel 215 to using a second set (or group) of training beams for the second antenna panel 215. In some examples, there may be one or more common beams shared between two groups or sets of beams used by the second antenna panel 215 across different positions 510. In some examples, there may be one or more common beams for two beam pairs across different positions 510. For example, a beam pair may include a first beam generated at the first antenna panel 210 and a second beam generated at the second antenna panel 215. Additionally, a beam pair may correspond to the use of two antenna panels for beam training and each beam of the beam pair may be associated with polarization MIMO aspects described elsewhere herein.

In some examples, the UE 205 may indicate one or more beams that can be used during beam switching. For instance, the control information 505 may include a parameter that indicates one or more beams generated at the first antenna panel 210 that the UE 205 can use during the movement periods 515. For example, while moving the second antenna panel 215 during the movement periods 515, the UE 205 may not perform wireless operations via the second antenna panel 215 (e.g., the second antenna panel 215 may be in an off-state, an idle-state, or a sleep-state). Therefore, the control information 505 indicates one or more beams at the first antenna panel 210 that the UE 205 may use for communications while moving the second antenna panel 215. Accordingly, the UE 205 may continue to communicate with the network node 110 during the movement periods 515 via the one or more beams (indicated via the control information 505), which may reduce gaps in wireless link connection between the UE 205 and the network node 110. In some examples, the one or more beams at the first antenna panel 210 may be one or more pre-trained beams (e.g., beams that were trained in a previous beam training procedure between the UE 205 and the network node 110). In some examples, the control information 505 may indicate the one or more beams by indicating one or more beam IDs respectively associated with the one or more beams.

In some examples, the UE 205 may indicate a rank change and a cause of the rank change. For instance, the control information 505 may include a parameter that indicates a rank change between the movement periods 515 and the training periods 525. As described elsewhere herein, the term “rank” may refer to the number of independent data streams that can be transmitted simultaneously between the UE 205 and the network node 110 using MIMO technology. For instance, rank-1 indicates a single data stream, while higher ranks, such as rank-2 or rank-4, respectively indicate two and four data streams, which can enhance data throughput and reliability. The rank may be determined by the channel conditions and the capabilities of the devices involved. Higher ranks may be used in environments with better signal quality and less interference. For example, based on the UE 205 not communicating using the second antenna panel 215 during movement periods 515, the control information 505 may indicate that the rank for communications between the UE 205 and the network node 110 is reduced during movement periods 515 (e.g., due to the time associated with changing the antenna panel configuration). In some examples, the control information 505 may indicate an explicit rank used during movement periods 515 and an explicit rank used during the training periods 525. In some examples, the control information 505 may indicate a differential rank change of the movement periods 515 relative to the training periods 525. For instance, if the UE 205 is capable of rank-4 during training periods 525 and rank-2 during movement periods 515, the control information 505 may indicate that the rank supported during movement periods 515 is reduced by two.

In some examples, the control information 505 may indicate one or more of a number of movement periods 515 included in the joint beam training procedure, a number of training periods 525 included in the joint beam training procedure, one or more identifiers respectively associated with one or more positions 510 of the second antenna panel 215 during the joint beam training procedure, or one or more identifiers respectively indicating one or more beams used by the UE 205 during one or more of the training periods 525.

In accordance with receiving the control information 505, the network node 110 may transmit, and the UE 205 may receive, a rate control process configuration 520 associated with the joint beam training procedure (e.g., via RRC signaling, MAC-CE signaling, or DCI signaling). For example, the network node 110 may use the rate control process configuration 520 to coordinate a configured rate control process for the UE 205 to use while performing the joint beam training procedure. In some examples, the rate control process configuration 520 may indicate for the UE 205 to use pre-trained beams at the first antenna panel 210 during the one or more training periods 525. In some examples, the rate control process configuration 520 may indicate for the UE 205 to use a rank 530a during the movement periods 515 and to use a rank 530b during the training periods 525. As shown in FIG. 5, the rank 530b may be higher than the rank 530a. For instance, in one example, the rate control process configuration 520 may configure rank-2 polarization MIMO communications at the first antenna panel 210 during the movement periods 515 and may configure rank-4 polarization MIMO communications at both the first antenna panel 210 and the second antenna panel 215 during the training periods 525.

In some examples, the network node 110 may indicate one or more beams that UE 205 can use during beam switching. For instance, the rate control process configuration 520 may include a parameter that indicates one or more beams of the first antenna panel 210 that the UE 205 can use during the movement periods 515. For example, while moving the second antenna panel 215 during the movement periods 515, the UE 205 may not perform wireless operations via the second antenna panel 215 (e.g., the second antenna panel 215 may be in an off-state, an idle-state, or a sleep-state). Therefore, the rate control process configuration 520 may indicate one or more beams at the first antenna panel 210 that the UE 205 may use for communications while moving the second antenna panel 215. Accordingly, the UE 205 may continue to communicate with the network node 110 during the movement periods 515 via the one or more beams (indicated via the control information 505), which may reduce gaps in wireless link connection between the UE 205 and the network node 110. In some examples, the one or more beams at the first antenna panel 210 may be one or more pre-trained beams (e.g., beams that were trained in a previous beam training procedure between the UE 205 and the network node 110). In some examples, the rate control process configuration 520 may indicate the one or more beams by indicating one or more beam IDs respectively associated with the one or more beams.

Based on communicating the control information 505 and the rate control process configuration 520, the UE 205 and the network node 110 may establish a rate control protocol for the joint beam training procedure. Accordingly, the established rate control protocol may circumvent the need for multiple rank hypotheses testing, thereby reducing network overhead. Additionally, based on the joint beam training procedure including a finite number of movement periods 515 and training periods 525, the network node 110 may enable automated rate control via the rate control process configuration 520. This automation eliminates back-and-forth signaling between the UE 205 and the network node 110, thereby reducing signaling overhead, optimizing the communication process, and reducing latency and resource consumption associated with the joint beam training procedure.

As indicated above, FIG. 5 is provided as an example. Other examples may differ from what is described with regard to FIG. 5.

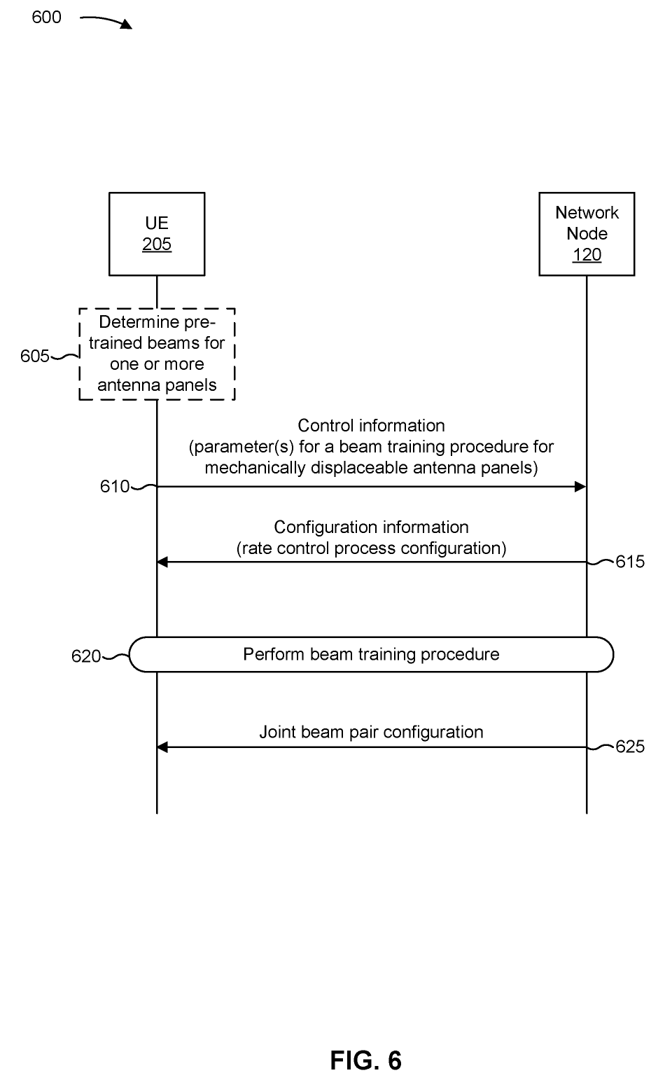

FIG. 6 is a diagram illustrating an example 600 associated with signaling that enables beam training for wireless devices including mechanically displaceable antenna panels. Example 600 may implement or be implemented by one or more aspects of FIGS. 1-5. For instance, example 600 includes wireless communications between the network node 110 and the UE 205. Alternative examples of the following may be implemented, where some operations are performed in a different order than described, or not described at all. In some cases, one or more operations may include additional features not mentioned below, or further operations may be added. In addition, while example 600 shows operations between the UE 205 and the network node 110, the communication may occur between any number of network devices of various types described herein.

In a first operation 605, the UE 205 may optionally determine one or more pre-trained beams for one or more antenna panels of the UE 205. For example, the one or more pre-trained beams may be based on one or more prior beam training results obtained at the UE 205 when the multiple antenna panels of the UE 205 were in a non-displaced state (e.g., the first antenna panel 210 and the second antenna panel 215 were co-located).

In a second operation 610, the UE 205 may transmit, and the network node 110 may receive, control information (e.g., the control information 505, with reference to FIG. 5). The control information may be included in a report. The UE 205 may transmit the control information via an uplink communication, a sidelink communication, a unicast communication, a broadcast communication, a UE 205 assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The control information may indicate one or more parameters associated with respective capabilities of the UE 205. The one or more parameters may be indicated via respective information elements (IEs) included in a report.

The control information may indicate one or more parameters associated with a beam training procedure for multiple antenna panels of the UE 205 that are mechanically displaceable relative to each other (e.g., a joint beam training procedure). For example, the one or more parameters included in the control information may be based on relative mechanical displacements between the multiple antenna panels during the beam training procedure.

In some examples, the one or more parameters may include an indication of a duration for switching from a first beam and antenna configuration associated with a first position of the second antenna panel 215 to a second beam and antenna configuration associated with a second position of the second antenna panel 215. As described elsewhere herein, the second antenna panel 215 may be an example of a “displacement antenna panel.”

In some examples, the one or more parameters may include a number of different positions through which at least the second antenna panel 215 may be displaced during the beam training procedure. As described elsewhere herein, displacement of an antenna panel can be in one or more of a vertical direction, a horizontal direction, an angular direction, or over an arc around the circumference of the UE 205.

In some examples, the one or more parameters may include an indication of one or more pre-trained beams to be used by the first antenna panel 210 during periods when a second antenna panel 215 of the multiple antenna panels is moving relative to a position of the first antenna panel 210 (e.g., during the one or more movement periods 515, with reference to FIG. 5). As described elsewhere herein, the first antenna panel 210 may be an example of an “anchor antenna panel.”

In some examples, the one or more parameters may include an indication of a rank change associated with the beam training procedure. For example, the rank change may indicate a change in a number of spatial streams used by the multiple antenna panels during one or more movement periods of the beam training procedure compared to one or more training periods of the beam training procedure.

In a third operation 615, the network node 110 may transmit, and the UE 205 may receive, configuration information that includes a rate control process configuration (e.g., the rate control process configuration 520, with reference to FIG. 5). In some aspects, the UE 205 may receive the configuration information via one or more of system information signaling (e.g., a master information block (MIB) or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UE 205. For example, in some aspects, the configuration information may at least partially be defined by a wireless communication standard, such as the 3GPP. In such examples, the network node 110 may not explicitly indicate such configuration information to the UE 205. For example, the UE 205 may optionally obtain at least a portion of the configuration information from a configuration stored by the UE 205 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may include an indication of one or more pre-trained beams to be used by the first antenna panel 210 during periods when a second antenna panel 215 of the multiple antenna panels is moving relative to a position of the first antenna panel 210 (e.g., during the movement periods 515).

In some examples, the configuration information may include a configuration for a rate control process to be used during the beam training procedure, where the configuration may be based on the one or more parameters of the control information. For example, the rate control process may indicate for the first antenna panel 210 to communicate via pre-trained beams during the one or more training periods, for the UE 205 to operate in accordance with a first rank indication (e.g., the rank 530a) during the one or more movement periods, and for the UE 205 to operate in accordance with a second rank indication (e.g., the rank 530b) during the one or more training periods. In some examples, the second rank indication may be higher than the first rank indication.

In a fourth operation 620, the UE 205 and the network node 110 may perform the beam training procedure. In some examples, the beam training procedure may be based on or in accordance with the one or more parameters of the control information or the rate control process configuration. The beam training procedure may include the UE 205 moving, during one or more movement periods, a position of the second antenna panel 215 of the multiple antenna panels relative to a position of the first antenna panel 210 of the multiple antenna panels. Additionally, the beam training procedure may include training, during one or more training periods, a set of beams across the first antenna panel 210 and the second antenna panel 215 for joint-beam communications. The UE 205 and the network node 110 may train the set of beams in accordance with one or more aspects of beam training described elsewhere herein.

In a fifth operation 625, the network node 110 may transmit, and the UE 205 may receive, a joint beam pair configuration based on performing the joint beam training procedure. For example, the joint beam pair configuration may include an indication of a preferred beam pair (e.g., a first beam at the first antenna panel 210 and a second beam at the second antenna panel 215) and a preferred relative mechanical displacement between the multiple antenna panels to use for one or more subsequent wireless communications.

In some examples, the network node 110 may determine the joint beam pair configuration based on one or more KPIs measured during the joint beam training procedure. For example, a KPI may be a measurable value that demonstrates how effectively an organization or system is achieving one or more configured objectives, often used to evaluate success in reaching targets or performance goals. KPIs used by the network node 110 for determination of the joint beam pair configuration can include various metrics that assess the quality and efficiency of network performance. For instance, the network node 110 may use a KPI associated with a downlink rate, that measures the data transfer speed from the network node 110 to the UE 205. Additionally, or alternatively, the network node 110 may use a KPI associated with interference between different beams of a beam pair, which may evaluate the level of signal disruption caused by overlapping beams and can affect the overall communication quality. Additional examples of KPIs may include latency (e.g., measures the time delay in data transmission), SNR (e.g., assesses the clarity of the signal in the presence of background noise), or handover success rate (e.g., associated with the efficiency of transitioning connections between different cells or beams without dropping the connection), among other examples. These KPIs collectively help in optimizing the performance of wireless communications between the UE 205 and the network node 110.

As indicated above, FIG. 6 is provided as an example. Other examples may differ from what is described with regard to FIG. 6.

FIG. 7 is a diagram illustrating an example process 700 performed, for example, at a UE or an apparatus of a UE. Example process 700 is an example where the apparatus or the UE (e.g., UE 120) performs operations associated with beam training for wireless devices including mechanically displaceable antenna panels.

As shown in FIG. 7, in some aspects, process 700 may include transmitting, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure (block 710). For example, the UE (e.g., using transmission component 904 or communication manager 906, depicted in FIG. 9) may transmit, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure, as described above.

As further shown in FIG. 7, in some aspects, process 700 may include performing the beam training procedure in accordance with the one or more parameters (block 720). For example, the UE (e.g., using communication manager 906, depicted in FIG. 9) may perform the beam training procedure in accordance with the one or more parameters, as described above.

Process 700 may include additional aspects, such as any single aspect or any combination of aspects described below or in connection with one or more other processes described elsewhere herein.

In a first aspect, the one or more parameters include an indication of a duration for switching from a first beam and antenna configuration associated with a first position of a displacement antenna panel of the multiple antenna panels to a second beam and antenna configuration associated with a second position of the displacement antenna panel.

In a second aspect, alone or in combination with the first aspect, the one or more parameters include a number of different positions through which at least one of the multiple antenna panels will be moved to during the beam training procedure.

In a third aspect, alone or in combination with one or more of the first and second aspects, the one or more parameters include an indication of one or more pre-trained beams to be used by an anchor antenna panel of the multiple antenna panels during periods when a displacement antenna panel of the multiple antenna panels is moving relative to a position of the anchor antenna panel.

In a fourth aspect, alone or in combination with one or more of the first through third aspects, process 700 includes receiving, from the network node before the beam training procedure, an indication of one or more pre-trained beams to be used by an anchor antenna panel of the multiple antenna panels during periods when a displacement antenna panel of the multiple antenna panels is moving relative to a position of the anchor antenna panel.

In a fifth aspect, alone or in combination with one or more of the first through fourth aspects, the one or more parameters include an indication of a rank change associated with the beam training procedure, where the rank change indicates a change in a number of spatial streams used by the multiple antenna panels during the beam training procedure.

In a sixth aspect, alone or in combination with one or more of the first through fifth aspects, process 700 includes receiving, from the network node before the beam training procedure, a configuration for a rate control process to be used during the beam training procedure, where the configuration is based at least in part on the one or more parameters.

In a seventh aspect, alone or in combination with one or more of the first through sixth aspects, the beam training procedure comprises one or more movement periods and one or more training periods, and the rate control process indicates for an anchor antenna panel of the multiple antenna panels to communicate via pre-trained beams during the one or more training periods, for the UE to operate in accordance with a first rank indication during the one or more movement periods, and for the UE to operate in accordance with a second rank indication during the one or more training periods.

In an eighth aspect, alone or in combination with one or more of the first through seventh aspects, the second rank indication indicates a second rank that is higher than a first rank indicated by the first rank indication.

In a ninth aspect, alone or in combination with one or more of the first through eighth aspects, performing the beam training procedure comprises moving, during one or more movement periods, a position of a displacement antenna panel of the multiple antenna panels relative to a position of an anchor antenna panel of the multiple antenna panels, and training, during one or more training periods, a set of beams across the anchor antenna panel and the displacement antenna panel for joint-beam communications.

In a tenth aspect, alone or in combination with one or more of the first through ninth aspects, the one or more parameters are based at least in part on prior beam training results obtained when the multiple antenna panels were in a non-displaced state.

In an eleventh aspect, alone or in combination with one or more of the first through tenth aspects, process 700 includes receiving, from the network node after performance of the beam training procedure, an indication of a preferred beam pair and a preferred relative mechanical displacement between the multiple antenna panels to use for one or more subsequent wireless communications.

In a twelfth aspect, alone or in combination with one or more of the first through eleventh aspects, the preferred beam pair and the preferred relative mechanical displacement are based at least in part on one or more KPIs measured during the beam training procedure.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with beam training for wireless devices including mechanically displaceable antenna panels.

As shown in FIG. 8, in some aspects, process 800 may include receiving, from a UE, control information that indicates one or more parameters associated with a beam training procedure for multiple antenna panels of the UE that are mechanically displaceable relative to each other, where the one or more parameters are based at least in part on relative mechanical displacements between the multiple antenna panels during the beam training procedure (block 810). For example, the network node (e.g., using reception component 1002 or communication manager 1006, depicted in FIG. 10) may receive, from a UE, control information that indicates one or more parameters associated with a beam training procedure for multiple antenna panels of the UE that are mechanically displaceable relative to each other, where the one or more parameters are based at least in part on relative mechanical displacements between the multiple antenna panels during the beam training procedure, as described above.

As further shown in FIG. 8, in some aspects, process 800 may include performing the beam training procedure in accordance with the one or more parameters (block 820). For example, the network node (e.g., using communication manager 1006, depicted in FIG. 10) may perform the beam training procedure in accordance with the one or more parameters, as described above.

Process 800 may include additional aspects, such as any single aspect or any combination of aspects described below or in connection with one or more other processes described elsewhere herein.

In a first aspect, the one or more parameters include an indication of a duration for switching from a first beam and antenna configuration associated with a first position of a displacement antenna panel of the multiple antenna panels to a second beam and antenna configuration associated with a second position of the displacement antenna panel.

In a second aspect, alone or in combination with the first aspect, the one or more parameters include a number of different positions through which at least one of the multiple antenna panels will be moved to during the beam training procedure.

In a third aspect, alone or in combination with one or more of the first and second aspects, the one or more parameters include an indication of one or more pre-trained beams to be used by an anchor antenna panel of the multiple antenna panels during periods when a displacement antenna panel of the multiple antenna panels is moving relative to a position of the anchor antenna panel.

In a fourth aspect, alone or in combination with one or more of the first through third aspects, process 800 includes transmitting, to the UE before the beam training procedure, an indication of one or more pre-trained beams to be used by an anchor antenna panel of the multiple antenna panels during periods when a displacement antenna panel of the multiple antenna panels is moving relative to a position of the anchor antenna panel.

In a fifth aspect, alone or in combination with one or more of the first through fourth aspects, the one or more parameters include an indication of a rank change associated with the beam training procedure, where the rank change indicates a change in a number of spatial streams used by the multiple antenna panels during the beam training procedure.

In a sixth aspect, alone or in combination with one or more of the first through fifth aspects, process 800 includes transmitting, to the UE before the beam training procedure, a configuration for a rate control process to be used during the beam training procedure, where the configuration is based at least in part on the one or more parameters.

In a seventh aspect, alone or in combination with one or more of the first through sixth aspects, the beam training procedure comprises one or more movement periods and one or more training periods, and the rate control process indicates for an anchor antenna panel of the multiple antenna panels to communicate via pre-trained beams during the one or more training periods, for the UE to operate in accordance with a first rank indication during the one or more movement periods, and for the UE to operate in accordance with a second rank indication during the one or more training periods.

In an eighth aspect, alone or in combination with one or more of the first through seventh aspects, the second rank indication indicates a second rank that is higher than a first rank indicated by the first rank indication.

In a ninth aspect, alone or in combination with one or more of the first through eighth aspects, process 800 includes transmitting, to the UE after performance of the beam training procedure, an indication of a preferred beam pair and a preferred relative mechanical displacement between the multiple antenna panels to use for one or more subsequent wireless communications.

In a tenth aspect, alone or in combination with one or more of the first through ninth aspects, the preferred beam pair and the preferred relative mechanical displacement are based at least in part on one or more KPIs measured during the beam training procedure.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 2-6. Additionally, or alternatively, the apparatus 900 may be configured to perform one or more processes described herein, such as process 700 of FIG. 7. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The communication manager 906 may perform the beam training procedure in accordance with the one or more parameters.

The reception component 902 may receive, from the network node before the beam training procedure, an indication of one or more pre-trained beams to be used by an anchor antenna panel of the multiple antenna panels during periods when a displacement antenna panel of the multiple antenna panels is moving relative to a position of the anchor antenna panel.

The reception component 902 may receive, from the network node before the beam training procedure, a configuration for a rate control process to be used during the beam training procedure, wherein the configuration is based at least in part on the one or more parameters.

The reception component 902 may receive, from the network node after performance of the beam training procedure, an indication of a preferred beam pair and a preferred relative mechanical displacement between the multiple antenna panels to use for one or more subsequent wireless communications.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 2-6. Additionally, or alternatively, the apparatus 1000 may be configured to perform one or more processes described herein, such as process 800 of FIG. 8. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive, from a UE, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure. The communication manager 1006 may perform the beam training procedure in accordance with the one or more parameters.

The transmission component 1004 may transmit, to the UE before the beam training procedure, an indication of one or more pre-trained beams to be used by an anchor antenna panel of the multiple antenna panels during periods when a displacement antenna panel of the multiple antenna panels is moving relative to a position of the anchor antenna panel.

The transmission component 1004 may transmit, to the UE before the beam training procedure, a configuration for a rate control process to be used during the beam training procedure, wherein the configuration is based at least in part on the one or more parameters.

The transmission component 1004 may transmit, to the UE after performance of the beam training procedure, an indication of a preferred beam pair and a preferred relative mechanical displacement between the multiple antenna panels to use for one or more subsequent wireless communications.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; and performing the beam training procedure in accordance with the one or more parameters.

Aspect 2: The method of Aspect 1, wherein the one or more parameters include an indication of a duration for switching from a first beam and antenna configuration associated with a first position of a displacement antenna panel of the multiple antenna panels to a second beam and antenna configuration associated with a second position of the displacement antenna panel.

Aspect 3: The method of any of Aspects 1-2, wherein the one or more parameters include a number of different positions through which at least one of the multiple antenna panels will be moved to during the beam training procedure.

Aspect 4: The method of any of Aspects 1-3, wherein the one or more parameters include an indication of one or more pre-trained beams to be used by an anchor antenna panel of the multiple antenna panels during periods when a displacement antenna panel of the multiple antenna panels is moving relative to a position of the anchor antenna panel.

Aspect 5: The method of any of Aspects 1-4, further comprising: receiving, from the network node before the beam training procedure, an indication of one or more pre-trained beams to be used by an anchor antenna panel of the multiple antenna panels during periods when a displacement antenna panel of the multiple antenna panels is moving relative to a position of the anchor antenna panel.

Aspect 6: The method of any of Aspects 1-5, wherein the one or more parameters include an indication of a rank change associated with the beam training procedure, wherein the rank change indicates a change in a number of spatial streams used by the multiple antenna panels during the beam training procedure.

Aspect 7: The method of any of Aspects 1-6, further comprising: receiving, from the network node before the beam training procedure, a configuration for a rate control process to be used during the beam training procedure, wherein the configuration is based at least in part on the one or more parameters.

Aspect 8: The method of Aspect 7, wherein the beam training procedure comprises one or more movement periods and one or more training periods, and wherein the rate control process indicates: for an anchor antenna panel of the multiple antenna panels to communicate via pre-trained beams during the one or more training periods, for the UE to operate in accordance with a first rank indication during the one or more movement periods, and for the UE to operate in accordance with a second rank indication during the one or more training periods.

Aspect 9: The method of Aspect 8, wherein the second rank indication indicates a second rank that is higher than a first rank indicated by the first rank indication.

Aspect 10: The method of any of Aspects 1-9, wherein performing the beam training procedure comprises: moving, during one or more movement periods, a position of a displacement antenna panel of the multiple antenna panels relative to a position of an anchor antenna panel of the multiple antenna panels; and training, during one or more training periods, a set of beams across the anchor antenna panel and the displacement antenna panel for joint-beam communications.

Aspect 11: The method of any of Aspects 1-10, wherein the one or more parameters are based at least in part on prior beam training results obtained when the multiple antenna panels were in a non-displaced state.

Aspect 12: The method of any of Aspects 1-11, further comprising: receiving, from the network node after performance of the beam training procedure, an indication of a preferred beam pair and a preferred relative mechanical displacement between the multiple antenna panels to use for one or more subsequent wireless communications.

Aspect 13: The method of Aspect 12, wherein the preferred beam pair and the preferred relative mechanical displacement are based at least in part on one or more key performance indicators (KPIs) measured during the beam training procedure.

Aspect 14: A method of wireless communication performed by a network node, comprising: receiving, from a user equipment (UE), control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; and performing the beam training procedure in accordance with the one or more parameters.

Aspect 15: The method of Aspect 14, wherein the one or more parameters include an indication of a duration for switching from a first beam and antenna configuration associated with a first position of a displacement antenna panel of the multiple antenna panels to a second beam and antenna configuration associated with a second position of the displacement antenna panel.

Aspect 16: The method of any of Aspects 14-15, wherein the one or more parameters include a number of different positions through which at least one of the multiple antenna panels will be moved to during the beam training procedure.

Aspect 17: The method of any of Aspects 14-16, wherein the one or more parameters include an indication of one or more pre-trained beams to be used by an anchor antenna panel of the multiple antenna panels during periods when a displacement antenna panel of the multiple antenna panels is moving relative to a position of the anchor antenna panel.

Aspect 18: The method of any of Aspects 14-17, further comprising: transmitting, to the UE before the beam training procedure, an indication of one or more pre-trained beams to be used by an anchor antenna panel of the multiple antenna panels during periods when a displacement antenna panel of the multiple antenna panels is moving relative to a position of the anchor antenna panel.

Aspect 19: The method of any of Aspects 14-18, wherein the one or more parameters include an indication of a rank change associated with the beam training procedure, wherein the rank change indicates a change in a number of spatial streams used by the multiple antenna panels during the beam training procedure.

Aspect 20: The method of any of Aspects 14-19, further comprising: transmitting, to the UE before the beam training procedure, a configuration for a rate control process to be used during the beam training procedure, wherein the configuration is based at least in part on the one or more parameters.

Aspect 21: The method of Aspect 20, wherein the beam training procedure comprises one or more movement periods and one or more training periods, and wherein the rate control process indicates: for an anchor antenna panel of the multiple antenna panels to communicate via pre-trained beams during the one or more training periods, for the UE to operate in accordance with a first rank indication during the one or more movement periods, and for the UE to operate in accordance with a second rank indication during the one or more training periods.

Aspect 22: The method of Aspect 21, wherein the second rank indication indicates a second rank that is higher than a first rank indicated by the first rank indication.

Aspect 23: The method of any of Aspects 14-22, further comprising: transmitting, to the UE after performance of the beam training procedure, an indication of a preferred beam pair and a preferred relative mechanical displacement between the multiple antenna panels to use for one or more subsequent wireless communications.

Aspect 24: The method of Aspect 23, wherein the preferred beam pair and the preferred relative mechanical displacement are based at least in part on one or more key performance indicators (KPIs) measured during the beam training procedure.

Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.

Aspect 26: An apparatus for wireless communication at a device, the apparatus comprising one or more memories and one or more processors coupled to the one or more memories, the one or more processors configured to cause the device to perform the method of one or more of Aspects 1-24.

Aspect 27: An apparatus for wireless communication, the apparatus comprising at least one means for performing the method of one or more of Aspects 1-24.

Aspect 28: A non-transitory computer-readable medium storing code for wireless communication, the code comprising instructions executable by one or more processors to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

Aspect 30: A device for wireless communication, the device comprising a processing system that includes one or more processors and one or more memories coupled with the one or more processors, the processing system configured to cause the device to perform the method of one or more of Aspects 1-24.

Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.

Aspect 32: A device comprising a processing system that includes one or more processors and one or more code-storing memories coupled with the one or more processors, the processing system configured to cause the device to perform the method of one or more of Aspects 1-24.

Aspect 33: A device comprising a processing system that includes processor circuitry and code-storing memory circuitry, the processing system configured to cause the device to perform the method of one or more of Aspects 1-24.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; and
perform the beam training procedure in accordance with the one or more parameters.

2. The UE of claim 1, wherein the one or more parameters include an indication of a duration for switching from a first beam and antenna configuration associated with a first position of a displacement antenna panel of the multiple antenna panels to a second beam and antenna configuration associated with a second position of the displacement antenna panel.

3. The UE of claim 1, wherein the one or more parameters include a number of different positions through which at least one of the multiple antenna panels will be moved to during the beam training procedure.

4. The UE of claim 1, wherein the one or more parameters include an indication of one or more pre-trained beams to be used by an anchor antenna panel of the multiple antenna panels during periods when a displacement antenna panel of the multiple antenna panels is moving relative to a position of the anchor antenna panel.

5. The UE of claim 1, wherein the one or more processors are further configured to cause the UE to:
receive, from the network node before the beam training procedure, an indication of one or more pre-trained beams to be used by an anchor antenna panel of the multiple antenna panels during periods when a displacement antenna panel of the multiple antenna panels is moving relative to a position of the anchor antenna panel.

6. The UE of claim 1, wherein the one or more parameters include an indication of a rank change associated with the beam training procedure, wherein the rank change indicates a change in a number of spatial streams used by the multiple antenna panels during the beam training procedure.

7. The UE of claim 1, wherein the one or more processors are further configured to cause the UE to:
receive, from the network node before the beam training procedure, a configuration for a rate control process to be used during the beam training procedure, wherein the configuration is based at least in part on the one or more parameters.

8. The UE of claim 7, wherein the beam training procedure comprises one or more movement periods and one or more training periods, and wherein the rate control process indicates:
for an anchor antenna panel of the multiple antenna panels to communicate via pre-trained beams during the one or more training periods,
for the UE to operate in accordance with a first rank indication during the one or more movement periods, and
for the UE to operate in accordance with a second rank indication during the one or more training periods.

9. The UE of claim 8, wherein the second rank indication indicates a second rank that is higher than a first rank indicated by the first rank indication.

10. The UE of claim 1, wherein the one or more processors, to cause the UE to perform the beam training procedure, are configured to cause the UE to:
move, during one or more movement periods, a position of a displacement antenna panel of the multiple antenna panels relative to a position of an anchor antenna panel of the multiple antenna panels; and
train, during one or more training periods, a set of beams across the anchor antenna panel and the displacement antenna panel for joint-beam communications.

11. The UE of claim 1, wherein the one or more parameters are based at least in part on prior beam training results obtained when the multiple antenna panels were in a non-displaced state.

12. The UE of claim 1, wherein the one or more processors are further configured to cause the UE to:
receive, from the network node after performance of the beam training procedure, an indication of a preferred beam pair and a preferred relative mechanical displacement between the multiple antenna panels to use for one or more subsequent wireless communications.

13. The UE of claim 12, wherein the preferred beam pair and the preferred relative mechanical displacement are based at least in part on one or more key performance indicators (KPIs) measured during the beam training procedure.

14. A method of wireless communication performed by a user equipment (UE), comprising:
transmitting, to a network node, control information that indicates one or more parameters associated with a beam training procedure for multiple antenna panels of the UE that are mechanically displaceable relative to each other, wherein the one or more parameters are based at least in part on relative mechanical displacements between the multiple antenna panels during the beam training procedure; and
performing the beam training procedure in accordance with the one or more parameters.

15. The method of claim 14, wherein the one or more parameters include an indication of a duration for switching from a first beam and antenna configuration associated with a first position of a displacement antenna panel of the multiple antenna panels to a second beam and antenna configuration associated with a second position of the displacement antenna panel.

16. The method of claim 14, wherein the one or more parameters include a number of different positions through which at least one of the multiple antenna panels will be moved to during the beam training procedure.

17. The method of claim 14, wherein the one or more parameters include an indication of one or more pre-trained beams to be used by an anchor antenna panel of the multiple antenna panels during periods when a displacement antenna panel of the multiple antenna panels is moving relative to a position of the anchor antenna panel.

18. The method of claim 14, further comprising:
receiving, from the network node before the beam training procedure, an indication of one or more pre-trained beams to be used by an anchor antenna panel of the multiple antenna panels during periods when a displacement antenna panel of the multiple antenna panels is moving relative to a position of the anchor antenna panel.

19. The method of claim 14, wherein the one or more parameters include an indication of a rank change associated with the beam training procedure, wherein the rank change indicates a change in a number of spatial streams used by the multiple antenna panels during the beam training procedure.

20. An apparatus for wireless communication, comprising:
means for transmitting, to a network node, control information that indicates one or more parameters associated with a beam training procedure for multiple antenna panels of the apparatus that are mechanically displaceable relative to each other, wherein the one or more parameters are based at least in part on relative mechanical displacements between the multiple antenna panels during the beam training procedure; and
means for performing the beam training procedure in accordance with the one or more parameters.
